(19) United States
(12) Patent Application Publication
(10) Pub. No.: US 2008/0162345 A1
(43) Pub. Date: Jul. 3, 2008

(54) NETWORK-BASED PAYMENT SYSTEM PRE-FUNDED ACCOUNTS

(75) Inventor: Prakash Passanha, Santa Clara, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 11/618,705

(22) Filed: Dec. 29, 2006

(51) Int. Cl. G06Q 40/00

(52) U.S. Cl. 705/44

(57) ABSTRACT

Some embodiments may provide a method comprising creating a first funded account, associating the first funded account with a first account identifier, receiving a valid activation message including the first account identifier, and, in response to receiving the valid activation message, placing the first funded account into an active state, the account being in an active state being a precondition to permitting a transfer of value from the first funded account to a second account.

### TECHNICAL FIELD

The present application relates generally to the technical field of methods and systems for network-based payment system pre-funded accounts.

### BACKGROUND

In recent years, the Internet has made possible the maintenance, by various entities (individuals, corporations, etc), of online accounts. These accounts typically are funded accounts or include funded account components. Entities may deposit various amounts of value (such as national or proprietary currency or other things of value) into these funded accounts and may use these funded accounts as sources of value transfers to facilitate purchase of good and services, especially (but not limited to) purchases from network-based commerce systems and other online merchants. These funded accounts, which may be maintained by network-based payment systems, may also be used as sources of value for transfer to other accounts.

### BRIEF DESCRIPTION OF THE DRAWINGS

Some embodiments are illustrated by way of example and not limitation in the figures of the accompanying drawings in which:

FIG. 1 is a block diagram of a system for creating, funding, and utilizing pre-funded accounts, according to an example embodiment.

FIG. 2 is a block diagram illustrating a number of example data structures that may be maintained by a network-based payment system, according to an example embodiment.

FIG. 3 is a flowchart illustrating a process including the creation, activation and utilization of a pre-funded account, according to an example embodiment.

FIG. 4 is a flow chart illustrating another process for creating, activating, and utilizing a pre-funded account, according to an example embodiment.

FIG. 5 is a flow chart illustrating yet another process for creating and activating a pre-funded account, according to an example embodiment.

FIG. 6 illustrates an example artifact in the form of a card associated with a pre-funded account, according to an example embodiment.

FIG. 7 illustrates the card of FIG. 6 after opaque material has been partially or otherwise removed, to reveal a login identifier and password associated with a pre-funded account, according to an example embodiment.

FIG. 8 illustrates an example of a graphical user interface that may be used by a customer or other entity to request a payment from an account maintained by a network-based payment system such as, for example, a pre-funded account, according to an example embodiment.

FIG. 9 illustrates a user interface that may be presented to a customer when a customer wishes to make a purchase via a network-based commerce system, according to an example embodiment.

FIG. 10 shows a diagrammatic representation of machine in the example form of a computer system within which a set of instructions, for causing the machine to perform any one or more of the methodologies, processes, or operations discussed herein, may be executed.

### DETAILED DESCRIPTION

Example methods and systems to facilitate network-based payment system pre-funded accounts are described. In the following description, for purposes of explanation, numerous specific details are set forth in order to provide a thorough understanding of example embodiments. It will be evident, however, to one skilled in the art that the present invention may be practiced in other embodiments without these specific details.

Introduction

This specification includes descriptions of various example embodiments of systems and methods to facilitate or implement network-based payment system pre-funded accounts. In a pre-funded account, a network-based payment system may create an account within an account database. In addition, in some embodiments the pre-funded account may be loaded with value before the account becomes the possession of a particular entity. For the purposes of this specification, the term “pre-funded” may be taken to mean that the account may already store value before the entity that is to ultimately possess the account obtains possession of the account. It will be appreciated that the creation of a pre-funded account need not include or be associated with the loading of the account with value. The term “funded account” may be taken to include accounts that are independent of other accounts wherein the full value that is indicated as being stored in the account is available for transfer out of, or otherwise removable from, the account independent of the status of any other account. A pre-funded account may be taken for purposes of this specification to be a type of funded account.

While some funded accounts may have value denominated in commercial currencies, a funded account may include value denominated in other things of value. In some embodiments, value may be denominated in other items of value, such as for example, reward points, frequent flyer miles, coupons, coins, tokens, securities, commodities, real estate, precious or base metal, notes, bonds, or shares of any of these items, or other things of value.

For purposes of this specification the term “debiting” may be taken to mean a reduction in a value stored in an account, while the term “crediting” may be taken to mean an increase in a value stored in an account.

In some embodiments, a customer or other entity wishing to obtain a pre-funded account may purchase or otherwise obtain an artifact such as, for example, a card that includes value transfer credential such as, for example, an account login and/or an access code (e.g., a password, personal identification number (PIN), etc.) from a reseller or other vendor. In some embodiments, this card may include an account identifier printed on the card as well as the value transfer credential. The value transfer credential (which may include an account login and/or an access code such as, for example, a password or PIN) may be obscured or concealed on the card by a layer of opaque material disposed so as obscure or conceal the value transfer credential and prevent the viewing of the value transfer credential prior to removal of the material. This opaque material serves to provide an assurance that the account to which the card is associated retains the entire amount of value that had been placed in it prior to the obtaining of the card by an entity (e.g., a person or a person acting on behalf of another entity, such as on behalf of a corporate entity.)

A value transfer credential may in some embodiments be a password, PIN or other passcode, or in some other embodiments, a password, PIN or other passcode, in combination with an account login such as for example an account login name, an email address, or other data, which may be publicly visible.

Once a customer has obtained a card or other artifact, the customer may login to the network-based payment system and make various types of payments or other transfers of value. For example, in carrying out electronic commerce, payments may be made to the benefit of a network-based commerce system such as, for example, an online merchant, or payments may be made directly another account maintained by the network-based payment system.

While this specification describes embodiments in which various types of data is transmitted and received or otherwise communicated via a network such as, for example, the Internet, it will be appreciated that various transmission media such as wireless networking, wired and wireless telephony, text messaging, internet telephony and many other media may be used to facilitate the various transmissions, receptions and acceptances described herein in regard to example systems for facilitating the transfer of value. Further, it will be appreciated that some embodiments, communication among the various systems and modules by be synchronous, asynchronous, or may be indirect, such as by one module storing a communication in a database or other storage device and indicating to another module its presence, without communicating its content.

For the purposes of this specification, a “module” includes an identifiable portion of code or data or computational object to achieve a particular function, operation, processing, or procedure.

Network-based payment system pre-funded accounts may have several example technical benefits. For example, because a pre-funded account can be created without a user needing to log in to set up the account, fewer IP address lookups to find the IP address of a network-based payment system web site may be required of domain name servers and fewer pages need to be served by network-based payment system web servers, thus reducing communication bandwidth and/or processor usage.

Example Systems for Creating and Using Network-Based Payment System Pre-Funded Accounts

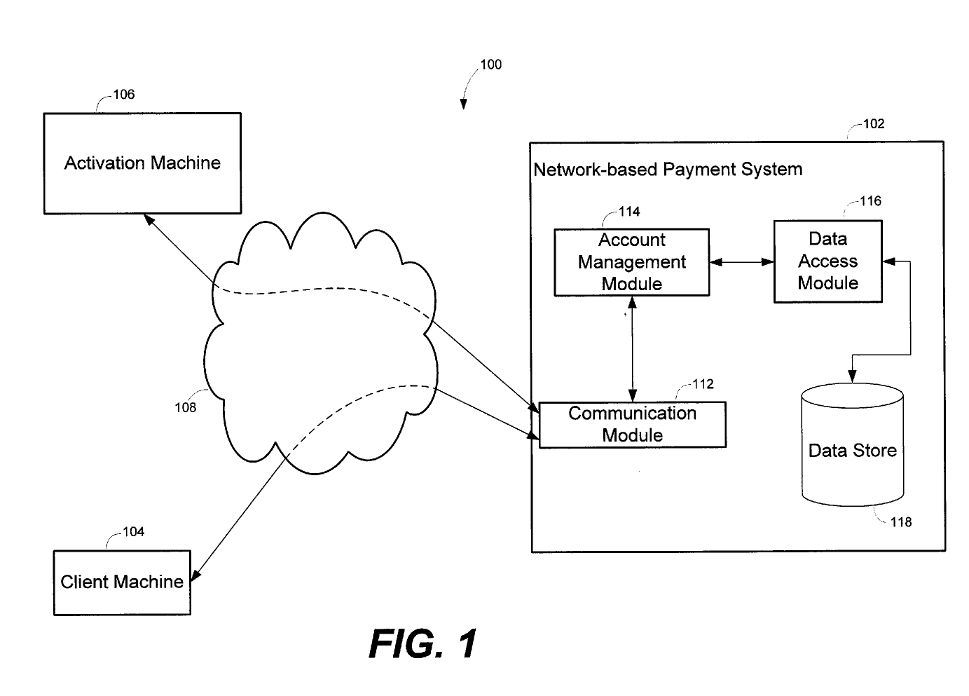

FIG. 1 is a block diagram of a system 100 for creating, funding, and utilizing pre-funded accounts, according to an example embodiment.

System 100 includes a network-based payment system 102. The network-based payment system 102 may manage one or more accounts on behalf of entities such as, for example, individuals, corporations, government agencies and the like. An example of a network-based payment system 102 is provided is PAYPAL® provided by eBay Inc. of San Jose, Calif. Network-based payment system 102 is connected to various customers, network-based commerce systems, merchants, resellers and other actors via one or more networks 108 such as, for example, the Internet or intranets. System 100 also includes one or more client machines 104 enabled to communicate with the network-based payment system 102 via network 108. The client machine 104 may be under the control of the owner of one or more accounts maintained by the network-based payment system 102.

After a pre-funded account has been created in an inactive state within the network-based payment system 102, the account may be activated. This activation may include setting the account into an active state as a precondition to allowing or permitting the owner of the account to make payments and/or otherwise effect transfers of value from the account. The activating of the account may also be associated with funding the account. In some embodiments, an activation machine 106 may communicate via the network 108 with the network-based payment system 102. In some embodiments, the resellers of pre-funded accounts may possess activation machines 106 that may be used to communicate with the network-based payment system 102 to transmit activation request messages thereto.

The network-based payment system 102 may include a number of components. The network-based payment system 102 may include a communication module 112 that serves to send and receive messages between the network-based payment system 102 and client machines 104 and activation machines 106. For example, the communication module may include web server or a voice response telephone system or other methods for communicating via the network 108. The reseller or activation machine may communicate with the network-based payment system 102 servers (e.g., communication module 112) in a secure mode using certificates for encryption and signing data. These certificates may be provided by the network-based payment system 102. The communication module 112 may communicate within the network-based payment system 102 with an account management module 114. The account management module may provide functionality for managing accounts, validating local or remote customer or client logins to the network-based payment system 102, validating and processing account activation requests, carrying out value transfers to and from the various accounts maintained by the network-based payment system 102, and gathering account information and/or analyzing information. A communication module 112 may in some embodiments include a web server application.

The account management module 114 may also communicate or collaborate with the data access module 116. The data access module provides data access functions into a data store 118 that may store account-related information such as, for example, information about various customers and entities that own the accounts, information that may be used or presented to activate one or more accounts and information about the accounts themselves such as the amounts of value stored in the account, whether an account is active or not, account transaction history and account logins, passwords or other value transfer credentials.

Example Data Structures for Storing Account-Related Information within a Network-Based Payment System

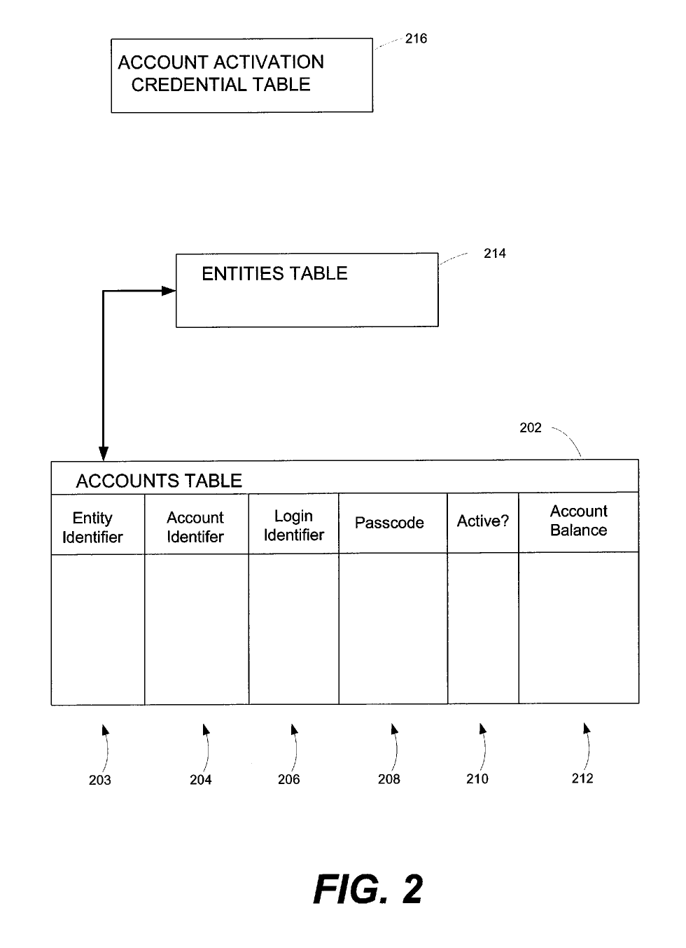

FIG. 2 is a block diagram illustrating a number of example data structures which may, for example, be in the form of relational or object oriented database tables that may be maintained by a network-based payment system 102, according to an example embodiment. These data structures may in some embodiments be stored in the data store 118 and/or may be managed by the data access module 116.

An accounts table 202 may be used to store information about various accounts maintained by the network-based payment system 102. The accounts table 202 may include a number of columns. Example columns may include a entity identifier column 203, an account identifier column 204, a login identifier column 206, a passcode column 208, an active column 210 and an account balance column 212. The entity identifier column 216 may, for each account contained or described in the accounts table 202, serve as a key into an entities table 214. The entities table 214 may include information about the entity or entities that owns or controls the particular account such as, for example, a personal or a corporate name, an address, telephone number or other information. It will be appreciated that when a pre-funded account is created, since the account may not yet been associated with any particular entity at the time of its creation, the entry in the entity identifier column for that account may be null. In some embodiments, once an entity has purchased a pre-funded account, the network-based payment system 102 may encourage the entity or other person acting on the entity's behalf to associate entity information with the account.

An account may include an account identifier which may be stored in the account identifier column 204. This account identifier may serve as a unique identifier for a particular account and may be referenced by a message to activate a particular pre-funded account.

In some embodiments, an accounts table may include a login identifier column 206 storing login identifiers for each account. In some embodiments, this login identifier may be an email address or other type of user name that the owner of an account may use when logging into the network-based payment system 102 to request a payment or other transaction. In some embodiments, the accounts table may also include a passcode column 208 that includes a password or other private key that may be used to authenticate (alone or in some embodiments, in combination with other data) a login or value transfer request by the owner or other authorized entity of a particular account. This value transfer credential may include the login or identifier or, in some embodiments, may be distinct from the login identifier insofar as the login identifier may be available publicly to facilitate transfers of value into a particular account with the value transfer credential remaining private to the account owners.

The accounts table may also include an active column 210. This column may be used to specify for each account whether the account is in an active state. In some embodiments, the semantics may be true=active state, false=inactive state. For the purposes of this specification, an account may be considered to be active when a person logging in to the network-based payment system 102 with a value transfer credential (e.g., matching that stored in a passcode column 208) associated with that account may request a transfer of value from the account. Pre-funded accounts may be initially created in an inactive state. The pre-funded account may later be activated by the communication module 112 receiving a valid activation message from a sender such as a pre-paid account vendor, at which time the account management module 114 may activate the account by setting the corresponding entry in the active column to true. When the active value is false, the network-based payment system 102 may reject value transfer requests even when the correct value transfer credential is associated with the request.

In addition, the accounts table 202 may include an account balance column 212 storing the current balance of the account. It will be appreciated that in some embodiments, the accounts table may be implemented using a number of different tables and the account may maintain a number of balances denominated in a variety of things of value, while in some other embodiments, only a single value denominated in a single currency may be stored in an account.

The network-based payment system 102 may also store an account activation credential table (or other account activation credential storing data structure) 206. The account activation credential table 216 may take various forms but may, in some embodiments, store a credential associated with one or more accounts. An account activation credential may be in the form of a secret code, key or other secret identifier which when presented in combination with a request to activate an account, may be used to validate that account activation request. In some embodiments, a single account activation credential may be used to activate any pre-funded account. In some other embodiments, each account may include a separate account activation credential. In some other embodiments, a group of pre-funded accounts to be sold by a particular reseller may share a single account activation credential. In these latter embodiments, the accounts table 202 may include a column providing a key into the account activation credential table 216 to indicate which activation credential or credentials may be used to validate an activation request message for that particular account. In some embodiments, an account activation message may be determined to be valid by virtue of a trusted relationship between the network-based payment system 102 and the person or organization empowered to activate pre-funded accounts. In those embodiments, the validity of an activation request may depend on authenticating that the activation request indeed came from the trusted person or organization, rather than on the presentation of a particular activation credential. When a person or organization having a trusted relationship with the network-based payment system sends a valid activation message, the person or organization may be termed a trusted sender of that message.

Example Processes for Creating, Activating and Utilizing Pre-Funded Accounts

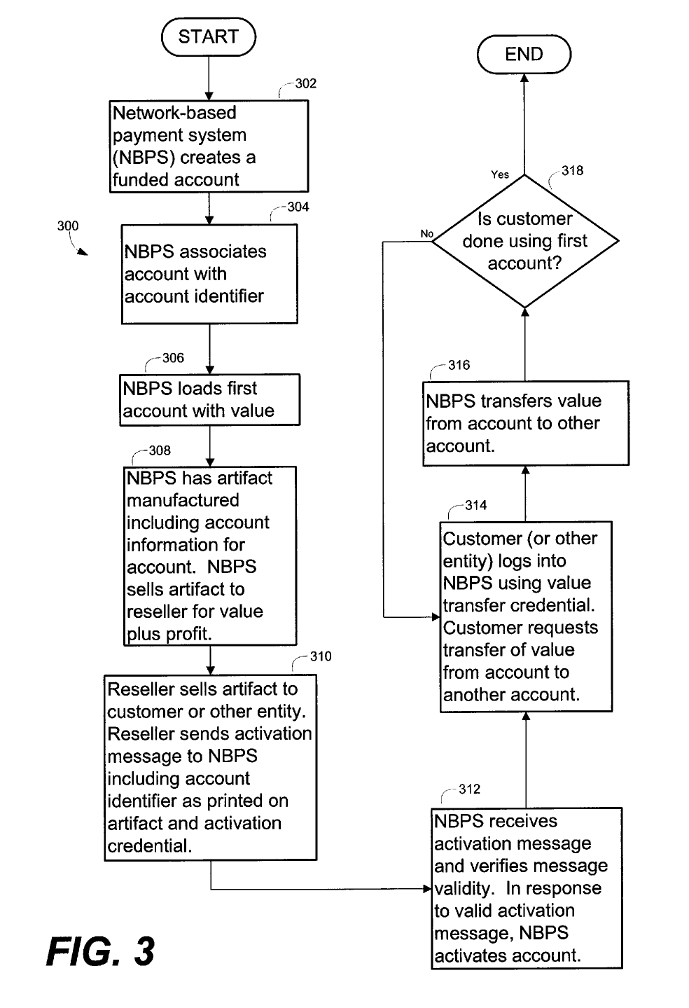

FIG. 3 is a flowchart illustrating a process 300 including the creation, activation and utilization of a pre-funded account, according to an example embodiment.

At block 302, a network-based payment system 102 may create a funded account. This may be carried out, in some embodiments by an account management module 114, by causing the addition of an account information row to the accounts table 202 in which the account balance may be initially set to zero an the active flag (e.g., in the active column 210) may be set to false or inactive. As part of the creation of the account, the account identifier, account login, and password or other value transfer credential may be automatically generated. At block 304, the network-based payment system 102 may associate the first account with a first account identifier such as, for example, an account identifier in column 204 of accounts table 202. This association may be carried out by generating an account identifier and causing (e.g., via the data access module 116) it to be entered into the table in the row of the new account in the account identifier column 204. At block 306 the network-based payment system 102 may load the first account with a value. This loading may be carried out by causing (e.g., via the data access module 116) the value to be entered into the table in the row of the new account in the account balance column 212. In some embodiments, this value may be selected to be a round number amount of value, such as may be appropriate for creation of accounts resembling or serving as gift cards. For example, the account may be pre-funded to include $10, $20 or $50.

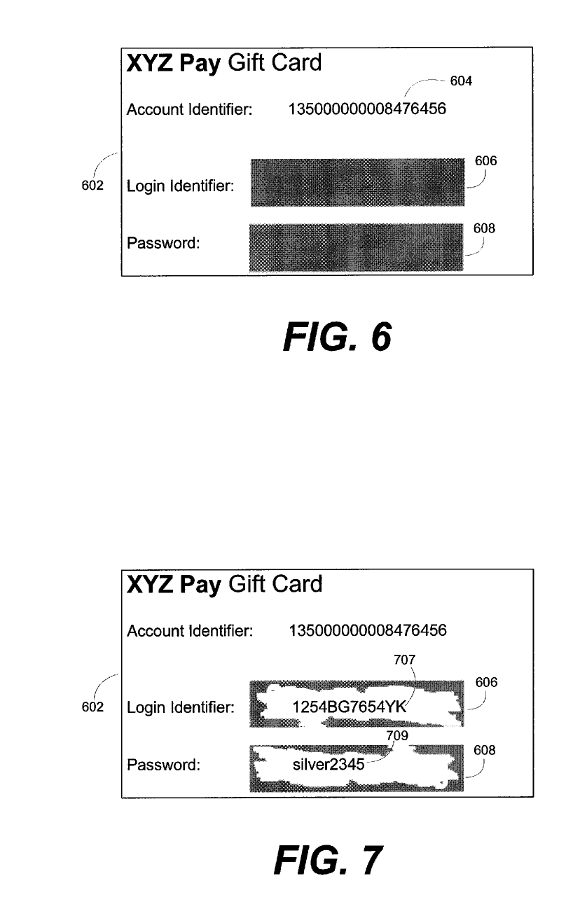

At block 308 the network-based payment system 102 may order the manufacturing of an artifact, such as for example a scratch-off card, to be associated with the first account. Further details on such cards are presented below with respect to FIGS. 6 and 7. This scratch-off card may include various pieces of account information such as, for example, an account identifier from the accounts table 202 pertaining to the account, a login identifier, and a value transfer credential, such as for example a PIN. In some embodiments, the network-based payment system 102 may have a scratch-off card manufacturer or other organization create the cards. In some embodiments as described in more detail below, the card associated with a particular account may be manufactured in such as way that the account identifier is printed visibly on the card or other artifact while the login identifier and/or value transfer credentials are printed on the artifact, but are obscured by a layer of opaque material.

It will be appreciated that a certain level of security may be utilized to enable the printing of cards associated with pre-funded accounts, in terms of protocols for providing a number of account login and value transfer credentials to a card manufacture to be printed onto cards or other artifacts.

Continuing the discussion of block 308: once the artifact has been manufactured, an administrator or other staffer of the network-based payment system 102 may sell the artifact to a reseller for the value that was pre-funded into the account in block 306, or in some embodiments, for the value with an additional profit to the benefit of the network-based payment system 102. For example, if an account A is created and loaded so as to contain the value of $20 at block 306, the artifact manufactured in block 308 may be sold to a reseller or other pre-funded account vendor for $20.25. At block 310, a reseller may sell the artifact to a customer or other entity wishing to obtain or gift the pre-funded account, thereby transferring ownership of the account to the customer. In some embodiments, the reseller may sell the pre-funded account for reseller's cost plus a small profit. For example, in the example above in which the pre-funded account A that had been pre-funded with $20 and its associated artifact sold to a reseller for $20.25, the reseller may sell this artifact to the customer or other entity for $20.50. Once the customer has purchased the card, the reseller or other agent may send an activation message (in some embodiments, via an activation machine 106) to the network-based payment system 102, to be received by the communication module 112. In this way, the reseller or other agent may be taken as the sender of the activation message. This activation message may include the account identifier that may be clearly visible on the card or other artifact sold to the customer, and the reseller may also associate the activation credential with the activation message. The presence of a valid activation credential in associating with the activation message may serve to validate the activation message.

It will be appreciated that there are a number of ways in which a reseller may activate the account associated with a card or other artifact. For example, the reseller may log into a secure website maintained by the network-based payment system 102, enter the account identifier from the card as well as an account activation credential that the administrators of the network-based payment system 102 has provided to the reseller. These pieces of information may be transmitted from a web browser running on an activation machine 106 maintained at the reseller's site to the network-based payment system 102 to the communication module 112 via secure hypertext transport protocol (HTTPS), encrypted email, or other secure communications methods. In some other embodiments, the network-based payment system 102 may maintain a telephonically activated communication module within or in addition to communication module 112. The reseller may, in that embodiment, call a particular phone number associated with the network-based payment system 102 and key-in or transmit by voice recognition the account identifier and activation credential. In some embodiments the association between an account activation credential and an account identifier, for the purposes of sending an activation message, need not be one to one. For example, a reseller may log into the network-based payment system 102 at the beginning of the day using an activation credential. Once the network-based payment system 102 has validated the activation credential, such as by use of the account management module 114 in collaboration with the data access module 116, the network-based payment system 102 may accept all further activation requests communicated during that secure login session (e.g., until the reseller logs out for the day) and activate accounts referenced by account identifiers within those activation requests. In some embodiments, a reseller may use two-factor authentication to log into the network-based payment system 102 for the purposes of activating accounts.

At block 312, the network-based payment system 102 may receive the activation request via communication module 112. In response, the account management module 114 may activate the account specified by the account identifier included in the activation message such as for example by instructing the data access module to set the active flag to true in the row of accounts table 202 corresponding to that account, to cause the account to enter an active state. In some embodiments, the activation of the account by the account management module may be in response to determining, based on a notification received from the communication module 112, whether the activation request is valid.

Once the account has become activated, the customer or other entity may at block 314 log into the network-based payment system 102 using the value of transfer credential printed on the artifact, the customer having removed the opaque layer obscuring the value transfer credential and/or the login identifier. The value transfer credential may be used to validate and facilitate customers' requests for transfers of value from the pre-funded account to a second or other account maintained by the network-based payment system 102. A customers' request for a transfer of value may specify the transfer request value, which may be the amount and denomination of value to be transferred.

In response to receiving a value transfer request (e.g., via communication module 112), at block 316, the network-based payment system 102 may transfer a value from the pre-funded account to the other account (e.g., via the account management module 114). In addition, the pre-funded account may also receive transfers of value from other accounts as arranged for example by a customer. Multiple transfers of value may be carried out using the value transfer credential until the customer is done using the pre-funded account. Once the customer is done using the pre-funded account as determined at block 318, the customer may close the account or in some embodiments if there is a small residual amount of value left in the account, the entity that owns the account may arrange for the network-based payment system 102 to aid the residual value such as for example by a check or in cash and then close the account. In addition, the customer can arrange to have the account replenished by receiving transfers of value from other sources (e.g., via check or receiving value into the account from another account maintained by the network-based payment system 102.)

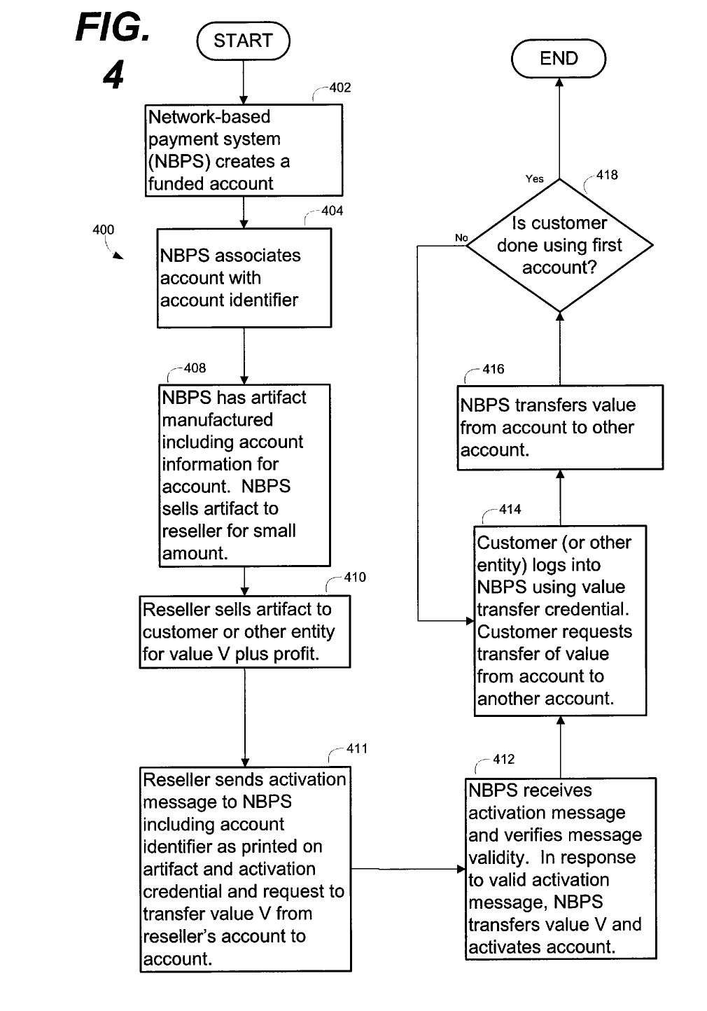

FIG. 4 is a flow chart illustrating a further process 400 for creating, activating, and utilizing a pre-funded account according to an example embodiment. It will be appreciated that process 400 bears some resemblance to process 300 illustrated in FIG. 3.

At block 402, a network-based payment system 102, such as via account management module 114, may create a funded account. At block 404, the network-based payment system 102 may (e.g., via the account management module 114) associate the account with an account identifier. Using a similar process to that of block 308 in FIG. 3, the network-based payment system 102 may arrange for the manufacturing of an artifact including the account information for the newly created account. Since the newly created account created at block 402 does not yet contain any value, the network-based payment system 102 may sell the artifact to a reseller for a small amount such as, for example, an amount sufficient to cover the manufacturing and distribution costs of the artifact. As in process 300 the artifact may be a scratch-off card.

At block 410, a reseller or other agent may sell the artifact to the customer or other entity for a value V, plus in some embodiments a small profit to cover the reseller's cost and the cost of producing the artifact from the network-based payment system 102. It will be appreciated that a customer or other entity may want to customize the values stored in the pre-funded account. At block 411 the reseller sends an activation message in the network-based payment system 102 including the account identifier as printed on the artifact and an appropriate activation credential as well as an indication of the value V. In some embodiments the reseller or other agent distributing the pre-funded accounts may maintain a reseller's account from which the value V is transferred into the newly created pre-funded account once the network-based payment system 102 has processed the account activation request. In those embodiments it may be the reseller's responsibility to periodically replenish the reseller's account with money taken in from selling cards or other pre-funded account-associated artifacts.

At block 412 the network-based payment system 102 may receive the activation message (e.g. via communication module 112) and may verify the message's validity, such as for example by comparing the activation credential transmitted by the reseller or other intermediary with the activation credential associated with the account requested to be activated. In some embodiments the activation credential may be the value transfer credentials associated with the reseller's account from which the funds are to be transferred into the newly created account. In response to a valid activation message the network-based payment system 102, for example, the account management module 114 may activate the account referenced in the activation request and transfer the value V from the reseller's account to that account. In some embodiments, once the reseller has received notification that this transfer has occurred, the reseller may physically give the card or other artifact to the customer. Blocks 414, 416 and 418 describe similar processing to the corresponding blocks of process 300 in which a customer may use the pre-funded account as a source of various value transfers.

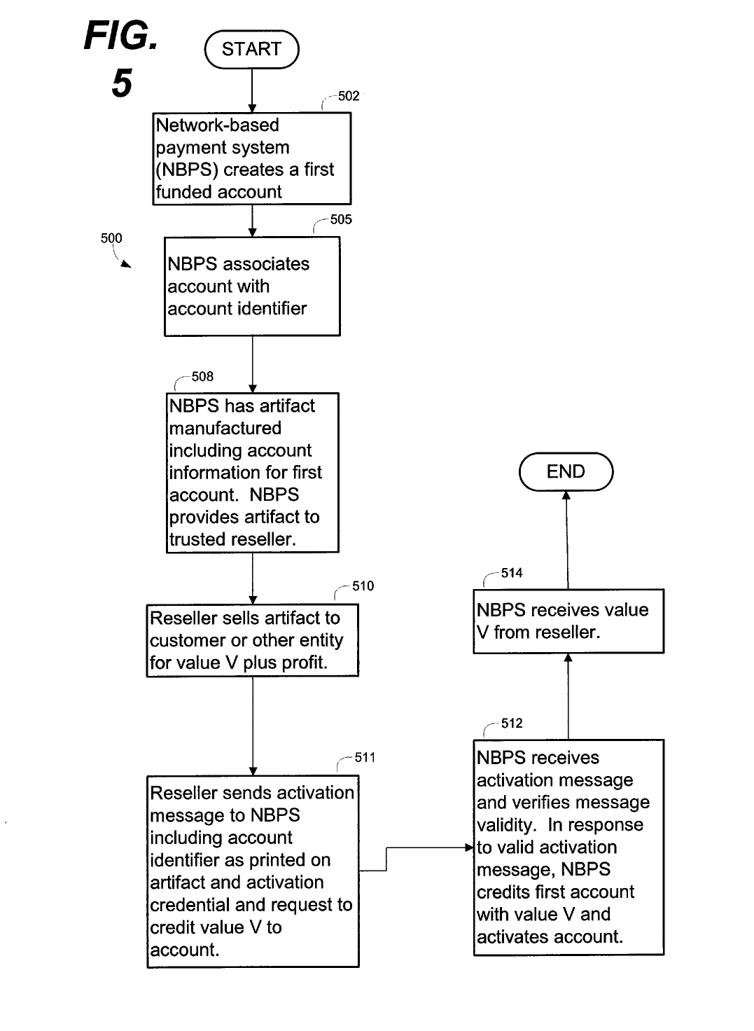

FIG. 5 is a flow chart illustrating a further process 500 for creating and activating a pre-funded account, according to an example embodiment.

At block 502, the network-based payment system 102 may create a funded account and at block 505 the network-based payment system 102 may associate the account with an account identifier, in similar manners as those described above. In similarity to the processes 300 and 400, at block 508 the network-based payment system 102 may arrange for the manufacturing of an artifact including account information for the newly created account. The network-based payment system 102 then provides the artifact to a trusted reseller.

A “trusted reseller” may, for purposes of this specification, be taken to include a person or organization that need not necessarily present an account activation credential or other secure key to activate a pre-funded account, for example, because of a high degree of fiduciary trust between the administrators of the network-based payment system and the reseller. For example, pre-funded accounts may be sold from vending machines that have a continuous or otherwise tamper-proof secure connection to the communication module 112 of the network-based payment system 102. These vending machines may, for example, take in money from a customer, send an account activation message to activate the account and dispense a card corresponding to that account. In this scenario, the account may be credited immediately based on the expectation of retrieving the corresponding amount of value from the vending machine. In some other embodiments a trusted reseller may include a person directly affiliated with the network-based payment system 102 whose fiduciary performance and responsibility may be closely monitored by the network-based payment system 102 administrators. In the case of a trusted reseller, the network-based payment system 102 may immediately credit the pre-funded account with a value as communicated by a trusted reseller as described below.

At block 510 the trusted reseller may sell the artifact to a customer or other entity for a value V, plus profit. In some embodiments this profit may be split among the trusted reseller and the network-based payment system 102 itself. Once the customer has purchased the artifact for value V, the reseller may send an activation message at block 511 to the network-based payment system 102, including the account identifier as printed on the artifact, and request to credit the value V to the account. In some embodiments the trusted reseller need not provide the activation credential, while in some other embodiments some other credential or key may be used to authenticate the activation request from, or the identity of, the trusted reseller.

At block 512 the network-based payment system 102 may receive the activation message and verify the message's validity. In some embodiments this validation of the activation message may occur by virtue of the fact that the activation message was verifiably transmitted by a trusted reseller. In response to the valid activation message the network-based payment system 102 may credit the newly created pre-funded account with the value V and activate the account. At this point the customer or other entity that owns the account, by virtue of having purchased the artifact from the trusted reseller, may use the value transfer credentials to carry out value transfers from the account. Eventually, at block 514 the network-based payment system 102 (or the administrators thereof) may receive the value V from the reseller, such as by receiving a check, cash, wire transfer or other negotiable instrument.

Examples of Cards or Other Artifacts

FIG. 6 illustrates an example artifact in the form of a card 602 associated with a pre-funded account, that may be purchased by a customer or other entity, according to an example embodiment.

Card 602 is illustrated in the form of an example gift card for a network-based payment system called “XYZ Pay”. The account identifier of the account to which this example card corresponds is indicated by representation 604. In addition, a login identifier and a password may be printed on the card. The login identifier and password taken together may be considered a value transfer credential, or in some embodiments, the password alone may be taken to be a value transfer credential. In the example card 602 in FIG. 6, the login identifier and password are obscured by an opaque layer of material, the opaque layer of material comprising two regions 606 and 608. In some embodiments, a single region of opaque material may cover printed representations of both the login identifier and password. It will be appreciated that the account identifier 604 is not covered in card 602 by opaque material, in order to allow the reseller or other person or machine to transmit an activation request using the account identifier 604 while not having access to the login identifier or password that may be used to actuate a transfer of value from the account to which the card 602 pertains.

To manufacture a card 602 or other artifact, printed representations of the account identifier and the value transfer credential (e.g., including in some embodiments and account login, passcode, etc.) is placed onto the artifact. Then the opaque material regions 606 and 608 may be applied.

FIG. 7 illustrates the card 602 after the opaque material has been scratched off or otherwise partially removed, to reveal the login identifier and password associated with the account, according to an example embodiment. The login identifier representation 707 is visible in the area of opaque material region 606 while the account password representation 709 is visible within the scratched off region of opaque region 608. It will be appreciated that once the login identifier and password have been revealed, it may be possible for a customer to login to the network-based payment system 102 such as, for example, via a secure connection via a web browser to the communication module 112 and request transfers of value validated by the account password 709, the transfer of value being carried out by the account management module 114. On the other hand, it will be appreciated that if the opaque material region 606 and 608 are already partially removed when the card 602 is offered to a customer for sale such as, for example at block 310, the customer may reject the card under the assumption that the account associated with the card may have had some of its value already transferred out. Although not illustrated in FIG. 6 or 7, the card or other artifact may include other information such as, for example, the initial value of the account or the value transferred into the account by the reseller at the time the card was purchased, or other decorative elements. It will be appreciated that, in addition to cards, numerous other artifacts may be utilized for the purposes described herein. In some embodiments, both the account identifier and the login identifier, may be visible and only the password may be obscured by opaque material region 608.

Cards wherein portions of printed matter are obscured by removable layers of opaque material may ordered from and manufactured by a number of manufacturers. Some examples of manufacturers include Scientific Games Corporation of New York, N.Y., Oberthur Gaming Technologies of Montreal, Quebec, Canada, and Pollard Banknote Limited of Winnipeg, MB, Canada.

Example User Interfaces for Value Transfer Requests

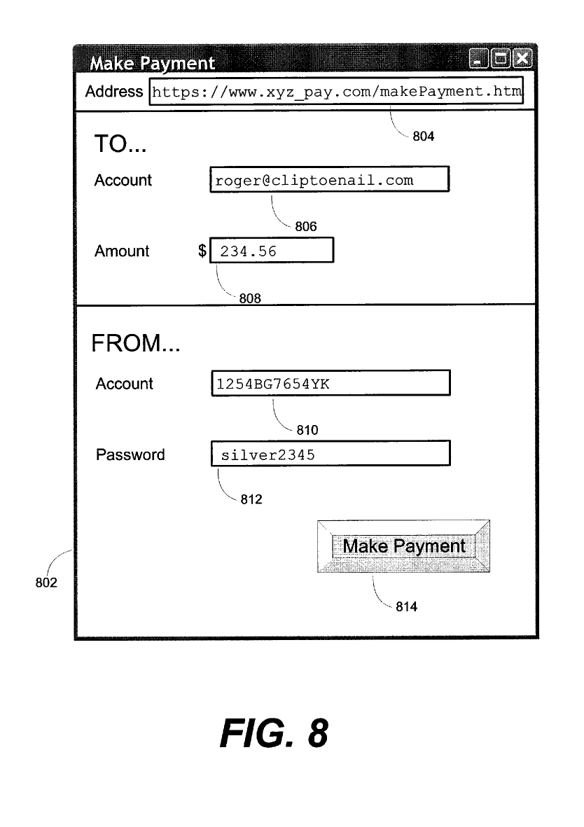

FIG. 8 illustrates an example of a graphical user interface that may be used by a customer or other entity to request a payment from an account maintained by a network-based payment system 102 such as, for example, a pre-funded account as created and initialized in processes 300, 400 or 500, according to an example embodiment.

The user interface 802, according to an example embodiment, may be used in carrying out the processing of block 314 or 414 to transfer value from one account to another. Where the accounts are maintained by the network-based payment system, a customer may log into the network-based payment system, such as through a web browser, inputting the URL into an address field 804 in a web browser. In response, the communication module 112 may serve a form to facilitate the entry of a source and destination of value transfer. In the example of FIG. 8, a user may enter an account login such as, for example, an email address associated with an account to which a value transfer is desired by entering the email address associated with the destination account into a text field 806. In addition, a customer may enter an amount into a text field 808. In the lower section of the form, the customer may enter the account login and value transfer credential such as, for example, a password, into the text fields 810 and 812, respectively. It will be appreciated that in the example illustrated in FIG. 8, the account login text field 810 and the password text field 812 are illustrated as if they had been filled in by a user in possession of the card 602 as illustrated in FIG. 7.

Once the source and destination information have been entered into the user interface 802, the user may click on a make payment button 814 to send a value transfer request to the network-based payment system 102, via the communication module 112, whereupon if the request data is valid, the account management module 114 may cause the data access module 116 to update the data store 118 to reflect the transfer of value between the accounts.

It will be appreciated that in some embodiments, a user may initiate a communication session (e.g., a secure HTTP session) with a network-based payment system 102, and once the communication session is initiated, enter valid transfer request credentials for an account, and subsequently request one or more transfers of value during the communication session without needing to reenter the transfer request credentials for each value transfer request.

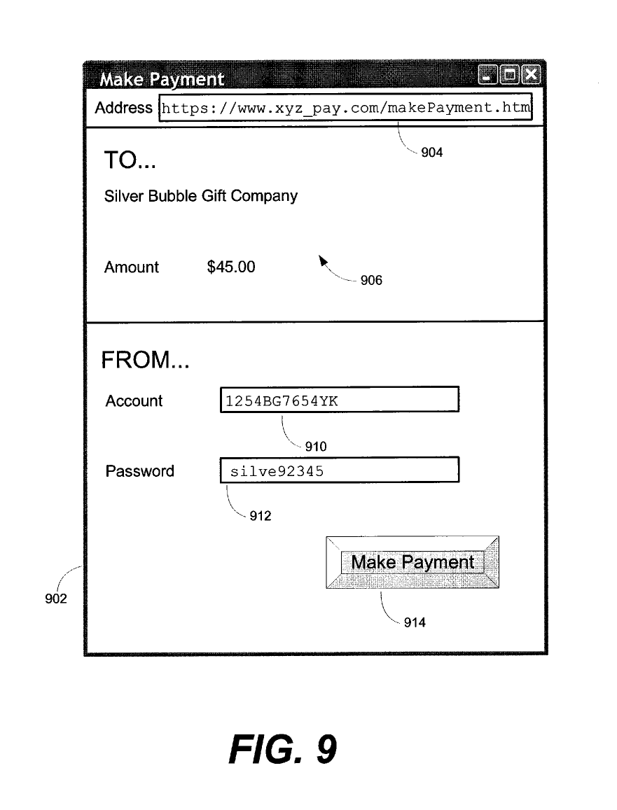

FIG. 9 illustrates a user interface 902 that may be presented to a customer when a customer wishes to make a purchase via a network-based commerce system, according to an example embodiment.

In some embodiments, a user may browse a network-based commerce system selecting various items or services that the user wishes to purchase. Eventually, the user may wish to purchase the items and after finalizing their order may be redirected to a website maintained by the network-based commerce system in order to make the payment to the benefit of the network-based commerce system. In the instruction (e.g., an HTTP post instruction) for redirecting the customer to the network-based payment system 102 website, the network-based commerce system may include the name of an online store or merchant implemented by the network-based commerce system, and the amount desired to be transferred in payment. In response, the network-based payment system 102 may be able to process the payment without requiring the customer to enter the account to which the transfer of value is to be made into or the amount to be transferred. Instead, this information may be summarized in the payment web form transmitted to the customer such as by, for example, the text 906.

As in the user interface illustrated in FIG. 8, the holder of a card associated with a pre-funded account may enter the account login and value transfer credential such as, for example, a password, into the lower section of the form illustrated within the user interface 902 into text fields 910 and 912, respectively. Once this is done, the customer may click on the “Make Payment” button 914 to effect the transfer of value, whereupon the network-based payment system 102 may effect the transfer of value to the benefit of the network-based payment system and may cause the user's browser to be redirected to a confirmation page served by the network-based commerce system.

Example Computer Systems for Carrying Out Operations

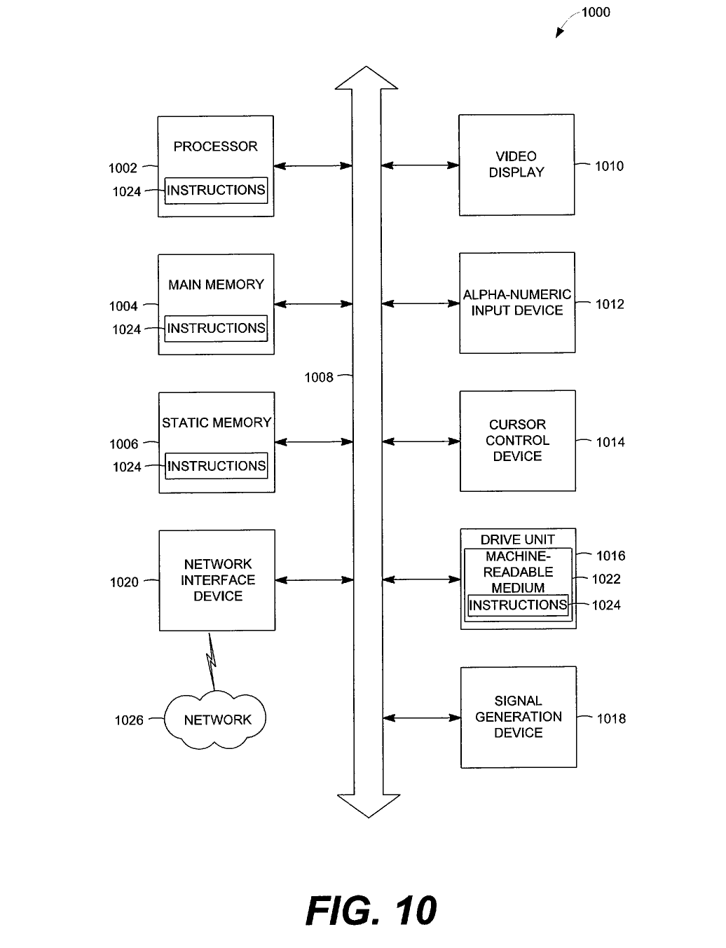

FIG. 10 shows a diagrammatic representation of machine in the example form of a computer system 1000 within which a set of instructions, for causing the machine to perform any one or more of the methodologies, processes, or operations discussed herein, may be executed. In some embodiments, a computer system 1000 may be used by a requestor to interact with a network-based commerce system and/or network-based payment system 102 110. One or more computer systems 1000 may, in some embodiments, be used to implement a network-based commerce system 104 and/or network-based payment system 102 110.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU) a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions (e.g., software 1024) embodying any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system for network-based payment system 102 pre-funded accounts has been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
an account management module to create a first funded account, to associate the first funded account with a first account identifier, and to place the first funded account in an active state upon the satisfaction of a precondition; and
a communication module to receive a valid activation message including the first account identifier, the communication module to provide a notification to the account management module to allow the account management module to determine whether the precondition is satisfied,
wherein satisfaction of the precondition places the first funded account in the active state and permits a transfer of value from the first funded account to a second funded account.

2. The system of claim 1, wherein the account management module is to credit the first funded account with a value.

3. The system of claim 1, wherein the account management module is to, prior to the receiving of the valid activation message, place the first funded account into an inactive state.

4. The system of claim 1, wherein the activation message is valid by virtue of having been verifiably transmitted by a trusted sender.

5. The system of claim 1, wherein the account management module is to associate the first funded account with an account activation credential and wherein the activation message is valid by virtue of being associated with the account activation credential;

6. The system of claim 5, wherein the activation message is associated with the account activation credential by including the account activation credential.

7. The system of claim 1, wherein the account management module is to fund the first funded account with a value debited from a third account associated with the sender of the activation message.

8. The system of claim 1, wherein the account management module is to associate a value transfer credential with the first funded account, a presentation of the value transfer credential, in combination with a transfer request value, being a precondition to effecting a transfer of the transfer request value from the first funded account to a second account.

9. The system of claim 8, wherein the communication module is to receive a value transfer request including the value transfer credential and a transfer request value, and the account management module is to effect a transfer of the transfer request value from the first funded account to the second account.

10. The system of claim 8, wherein the communication module is to, during a communication session, receive the value transfer credential and a value transfer request including a transfer request value, and the account management module is to effect a transfer of the transfer request value from the first funded account to the second account.

11. A method comprising:
creating a first funded account;
associating the first funded account with a first account identifier;
receiving a valid activation message including the first account identifier; and
in response to receiving the valid activation message, placing the first funded account into an active state, the first funded account being in an active state being a precondition to permitting a transfer of value from the first funded account to a second account.

12. The method of claim 11, further comprising crediting the first funded account with a value.

13. The method of claim 11, further comprising placing the first funded account into an inactive state.

14. The method of claim 11, wherein the activation message is valid by virtue of having been verifiably transmitted by a trusted sender.

15. The method of claim 11, further comprising associating the first funded account with an account activation credential and wherein the activation message is valid by virtue of being associated with the account activation credential.

16. The method of claim 15, wherein the activation message is associated with the account activation credential by including the account activation credential.

17. The method of claim 11, further comprising funding the first funded account with a value debited from a third account associated with the sender of the activation message.

18. The method of claim 11, further comprising associating a value transfer credential with the first funded account, a presentation of the value transfer credential, in combination with a transfer request value, being a precondition to effecting a transfer of the transfer request value from the first funded account to a second account.

19. The method of claim 18, further comprising:
receiving a value transfer request including the value transfer credential and a transfer request value; and
effecting a transfer of the transfer request value from the first funded account to the second account.

20. The method of claim 18, further comprising:
receiving, during a communication session, the value transfer credential;
receiving, during the communication session, a value transfer request including a transfer request value; and
effecting a transfer of the transfer request value from the first funded account to the second account.

21. The method of claim 18, wherein the transfer of value is to the benefit of a network-based commerce system.

22. The method of claim 18, wherein a representation of the value transfer credential is printed on an artifact, the representation of the value transfer credential being concealed by removable opaque material.

23. The method of claim 22, wherein the artifact is a card.

24. The method of claim 22, wherein the first account identifier is printed on the artifact.

25. The method of claim 18, wherein the value transfer credential includes a passcode.

26. The method of claim 25, wherein the value transfer credential includes a login identifier.

27. The method of claim 25, wherein the passcode is a password.

28. The method of claim 18, wherein the value transfer credential includes a personal identification number (PIN).

29. A method comprising:
printing a first representation of a value transfer credential upon an artifact of printable material;
printing a second representation of an account identifier upon the artifact; and
placing a layer of opaque material on the artifact, the opaque material being disposed so as to prevent viewing of the first representation, the opaque material being removable to allow viewing of the first representation,
wherein the value transfer credential is associated with a first funded account, a presentation of the value transfer credential being a precondition to effecting a transfer of value from the first funded account to a second account.

30. An article of manufacture comprising:
a printable sheet of material;
a first representation of a value transfer credential, the first representation being printed upon the sheet;
a second representation of an account identifier, the second representation being printed upon the sheet; and
a layer of opaque material, disposed so as to prevent viewing of the first representation, the opaque material being removable to allow viewing of the first representation,
wherein the value transfer credential is associated with a first funded account, a presentation of the value transfer credential being a precondition to effecting a transfer of value from the first funded account to a second account.

31. A machine-readable medium comprising a plurality of instruction sets, the plurality of instruction sets comprising:
a first instruction set to cause a machine to create a first funded account;
a second instruction set to cause the machine to associate the first funded account with a first account identifier;
a third instruction set to cause the machine to receive a valid activation message including the first account identifier; and
a fourth instruction set to cause the machine to, in response to receiving the valid activation message, place the first funded account into an active state, the first funded account being in an active state as a precondition to permitting a transfer of value from the first funded account to a second account.

32. A system comprising:
a first means for creating a first funded account;
a second means for associating the first funded account with a first account identifier;
a third means for receiving a valid activation message including the first account identifier; and
a fourth means for, in response to receiving the valid activation message, placing the first funded account into an active state, the first funded account being in an active state being necessary to permit a transfer of value from the first funded account to a second account.
